(19) United States
(12) Patent Application Publication
(10) Pub. No.: US 2009/0226579 A1
(43) Pub. Date: Sep. 10, 2009

(54) Fish and meat curing process

(75) Inventor: Ernie Balbutin Calamian, Puerto Princesa (PH)

Correspondence Address: Crowell Ing, LLP, P. O. BOX 923, SALEM, OR, 97308-0923, US

(73) Assignee: Tuna Processors, Inc., Temecula, CA (US)

(21) Appl. No.: 12/074,914

(22) Filed: Mar. 7, 2008

(51) Int. Cl. A23B 4/16; A23B 4/10

(52) U.S. Cl. 426/268

(57) ABSTRACT

The method of preserving meat products comprising the steps of soaking the meat product with a chilled soaking solution comprising of potable water, sodium bicarbonate, citric acid, and sodium chloride. Next extract the meat product from the chilled soaking solution and draining the chilled soaking solution from the meat product. Then place the meat product inside a polyethylene bag and removing all the air content from the polyethylene bag and filling said polyethylene bag with pure O2 or high O2 content gas. The above process not only sterilizes the meat product thus preventing the formation of harmful bacteria and preventing decay, but will also help the meat product retain its original flavor and fresh appearance even after refrigeration.

### CROSS REFERENCE TO RELATED APPLICATIONS

This application contains disclosure from and claims the benefit under Title 35, United States Code, §119(e) of the following U.S. Provisional Application: U.S. Provisional Application Ser. No. 80/894,212 Filed Mar. 10, 2007 entitled FISH AND MEAT CURING PROCESS.

### FIELD OF THE INVENTION

This invention relates to a method for sterilizing meat products including fish food products. More particularly, the present invention relates to the method of preventing decomposition and discoloration of the meat products.

### BACKGROUND OF THE INVENTION

In the modern global market, the import and export of food products is a trillion dollar industry. The tuna we eat here in the US often originates from Japan or the Philippines, while the beef served in Japan may come from the US or Europe. As more and more food products traverse the globe to reach its destination, the need for a faster, efficient, and effective process of preserving such meat products is needed.

The decay of meat products including fish meat is caused by the growth of organisms like putrefactive or decaying bacteria such as fungi. The decaying process in fish meat is even more accelerated due to the rapid growth of bacteria such as Physchotricpic type, including Pseudomonas and Achromobacter. The decaying process can be hindered through the removal of water content from the meat and lowered storage temperature. However, meat products stored below freezing for long periods of time as a matter of course will undergo deterioration and quality loses. Furthermore, thawing such frozen or refrigerated meats may cause deterioration in meat quality that not only affects the quality of the meat product, but also the appearance and coloration of the meat product.

Appearance of the meat product is another major factor in the sale of treated and frozen meat products. Buyers associate a bright red color with fresh meat. Meat which has turned brown or grayish brown, even though it has been cut within 24 hours, is often rejected as unacceptably old.

The color change of meat is caused by the alteration of myoglobin contained in meats. The color of meats such as beef and tuna is altered depending on the type and ratio of myoglobin derivatives present therein. Herein, as types of myoglobin derivatives, there exist the reduced type myoglobin, oxymoglobin and metmyoglobin. The reduced type myoglobin is purple red, oxymyoglobin is scarlet, and metmyoglobin is brown. Consumers of these products prefer their meat to be scarlet and associate the browning of the meat to mean the lack of freshness. Therefore, a process which drastically slows down the browning of meat products, and helps maintain the reduction type oxymoglobin is needed.

The prior arts have attempted to address the above problems but without the efficiency and effectiveness of the current invention.

The use of a bicarbonate solution which inhibits the formation of spoilage causing bacteria is know in the prior art. U.S. Pat. No. 5,196,221 for example, teaches of a solution comprised of roughly 8% by weight sodium bicarbonate to treat food product. Although this alone can kill a large amount of the bacteria for roughly eight days, it is still very limited in duration and fails to address the issues of preserving both the taste and coloration of the treated products.

U.S. Pat. No. 5,939,112 teaches of a method of processing animal meat with a combination of sodium chloride as the sodium bicarbonate or sodium carbonate as the alkali in a given ratio. The above preserving solution is physically injected into the treated food product and then the food product is manually folded and compressed as part of the process. The short coming of this prior art is that the preserving effects of this invention may leave the meat product elastic in nature. Furthermore, a process that includes the expensive steps of injecting the preserving solution into the meat and folding the meat product and manually compressing the meat together can be overly complicated. The folding and compression of the food product would also only work from some food products as it would destroy the integrity of fish meat such as tuna.

U.S. Pat. No. 6,627,237 (Inventor Naito) teaches of a combination of alkali metal halide, alkali metal bicarbonate, organic acid, gelatin, and polylysine as a soaking solution for food products. Although the teaching of this patent and its objectives are similar to the current invention, it can be distinguished in many ways. First, the process is over complicated by using compounds such as polylysine and gelatin in its soaking solution. Furthermore, the use of alkali metal bicarbonate in Naito's invention is very limited, and its preservation process is more reliant on its high alkali metal halide content. Like the other prior arts listed above, Naito stops short of the present invention and fails to properly address the issue of preserving the red coloration of meat for a long period of time after the frozen food product has be defrosted.

The issue of preserving the coloration of meat products has also be touched upon in the prior arts. U.S. Pat. No. 3,047,404 and 6,045,845 teach of a blooming process in which it promotes the oxymoglobin stage of the meat product thus allowing the meat to stay red for a longer period of time. However, both of these patents fail to go beyond the simply process of exposing the meat product to pure O2 gas. Unlike the teachings of the present invention, the above patents fail to teach of a complete process that would not only expose the meat product to an high O2 environment, but also to treat the meat itself to better react with that environment to further prolong the oxymoglobin stage.

Thus a method of extending the storage and shelf life of meat products by inhibiting the growth of spoilage and odor causing bacteria and retarding the natural discoloration of frozen or exposed meat products in a effective and efficient manner has long been sought.

### SUMMARY OF THE INVENTION

Therefore, the present invention has the objective of providing a process in which meat products can be treated to better retard the bacteria that cause spoilage, while at the same time keeping the texture, taste, and coloration of the meat product similar to its original fresh state.

The above objective is reached by preparing a soaking solution comprised of potable water, sodium bicarbonate, alkali metal halide, and organic acid. The meat product is then submersed in the soaking solution. The soaking solution containing sodium bicarbonate, alkali metal halide, and organic acid combination not only kills spoilage causing bacteria, it also promotes the decrease of dissolved oxygen concentration in the soaking solution as compared to a pure water solution. The low concentration of dissolved oxygen content in the soaking solution further contributes to drastically slowing reduction of oxymyoglobin and further slowing down oxidation to which leads to metmyoglobin that results in the browning of meat products.

The percentage of weight of each ingredient in the soaking solution is contingent on the food product being treated. Sodium bicarbonate may be used in an approximate range of 3% by weight to 6% by weight, preferably from approximately 4% by weight to 6% by weight, and more preferably from approximately 4% by weight to 5% by weight.

The alkali metal halide may be used in an approximate range of 0.018% by weight to 0.036% by weight.

The organic acid may be used in approximate range of 0.012% by weight to 0.024% by weight.

Once the soaking stage is complete, the meat product is removed and the extraction stage begins. In the extraction stage, the objective is to extract some of the liquid content from the meat product. This can be done by means of an absorbent material, suction device or any other methods known in the art. After the extraction sage, the treated meat product is placed inside a packaging material whereby all the air inside the packaging material is removed and replaced with a pure or a high O2 gas environment.

The O2 gas is important because it will penetrate and dissolve into the meat product. The organic acids such as citric acid already absorbed by the meat product during the soaking process tend to retard the oxidation of MbO2 that form metmyoglobin (MMb) due to its anti-oxidation function. As a result, the blooming of reduced type myoglobin core is completed before the oxidation of the MbO2 considerably takes place for the browning color to be recognized.

The finished product then is ready to be frozen and shipped. The result of the above process produces a meat product that is similar in taste, feel, and look of fresh unfrozen meat product.

### DETAILED DISCUSSION OF THE PREFERRED EMBODIMENTS

In accordance with the process of the invention, the following preferred embodiment illustrates the process in treating meat products. The type of meat products for use with the present invention are not limited to particular types of meat and can include all types of seafood, red meat, poultry, shell fish, etc.

The following working example is used to further illustrate the preferred embodiment. Fresh raw tuna was filleted and the produced tuna meat immersed in a chilled soaking solution for around five minutes wherein the soaking solution comprised of 95.19% by weight potable water, 4.76% by weight sodium bicarbonate, 0.02% by weight citric acid, and 0.03% by weight sodium chloride.

The tuna meat should then be placed in a drainer to remove the majority of the solution from the tuna meat. A suction device may be used to further drain any remaining solution from the tuna meat. After drainage, the tuna meat is placed inside a polyethylene bag wherein all the air inside the polyethylene bag is removed. Next, fill the polyethylene bag with pure O2 and seal the bag. Then place the tuna meat in a chilled room within 24 hours of this process.

The resulting tuna not only has an extended shelf life without spoilage but also retains the scarlet coloration customers associate with fresh meat.

Accordingly, the reader will see that the method of curing meat products taught in the present embodiment is effective in retarding spoilage causing bacteria and helps the meat product retain a red/scarlet color even after undergoing subzero temperatures.

Throughout the specification the aim has been to describe the invention without limiting the invention to any one embodiment or specific collection of features. Persons skilled in the relevant art may realize variations from the specific embodiment that will nonetheless fall within the scope of the invention. For example, the meat products need not be raw but can be cooked or preprocessed. This embodiment need not be limited to any particular types of meat product. The percentages by volume of active ingredients in the soaking solution are not limited to the exact percentages given in the preferred embodiments, but are dependent on the type of meat product being treated. The soaking stage can be achieved through immersing, coating, or mixing of the meat product with the soaking solution. The drainage stage of the process can be done by any know prior art. The packaging material is not limited to polyethylene bag, but can be durable material that is deemed air tight.

Accordingly, the scope of the invention should be determined not by the embodiments illustrated, but by the appended claims and their legal equivalents.

We claim:

1. The method of preserving meat products comprising:
a. Soaking, coating, spraying, or mixing a meat product with a soaking solution comprising a percentage by weight of water, a percentage by weight of sodium bicarbonate, a percentage by weight of an organic acid and a percentage by weight of an alkali metal halide;
b. extracting said meat product from the said soaking solution and draining said soaking solution from the meat product;
c. placing said meat product inside a packaging material;
d. removing all air content from the said packaging material; and
e. filling said packaging material with an O2 gas.

2. The method of preserving meat products claimed in claim 1 wherein the said soaking solution is chilled.

3. The method of preserving meat products claimed in claim 1 wherein the said soaking solution comprises of 3% to 6% by weight sodium bicarbonate, 0.012% to 0.024% organic acid, and 0.018% to 0.036% alkali metal halide.

4. The method of preserving meat products claimed in claim 1 wherein the said packaging material is a polyethylene bag.

5. The method of preserving meat products claimed in claim 1 wherein the said O2 gas can be a pure O2 gas

6. The method of preserving meat products claimed in claim 1 where in the said O2 gas can be a high concentrate of O2 gas.

7. The method of preserving meat products claimed in claim 1 wherein the said organic acid is acetic acid, citric acid or lactic acid, or a mixture thereof.

8. The method of preserving meat products of claimed in claim 1 wherein the said alkali metal halide is sodium chloride.

9. The method of preserving meat products of claimed in claim 1 wherein the said draining said soaking solution from the meat product is performed with a absorbent material.

10. The method of preserving meat products of claimed in claim 1 wherein the said draining said soaking solution from the meat product is performed with a suction device.

11. The method of preserving meat products of claimed in claim 1 wherein the said meat product includes but is not limited to animal meat, fish meat, and seafood.

12. The method of preserving meat products of claimed in claim 1 wherein the said a percentage by weight of water is a percentage by weight of potable water.

13. A curing composition solution comprising of a percentage of water, a 3% to 6% by weight sodium bicarbonate, 0.012% to 0.024% by weight organic acid, and a 0.018% to 0.036% by weight alkali metal halide.

14. A curing composition of claim 13 wherein the said organic acid is acetic acid, citric acid or lactic acid, or a mixture thereof.

15. The curing composition solution of claim 13 wherein the said alkali metal halide is sodium chloride.

16. The curing composition solution of claim 13 wherein the said percentage by weight of water is a percentage by weight of potable water.
